(19) United States
(12) Patent Application Publication
(10) Pub. No.: US 2010/0080378 A1
(43) Pub. Date: Apr. 1, 2010

(54) Accommodating telecommunications call-center

(75) Inventor: Bryan S. Katz, Freehold, NJ (US)

Correspondence Address: Avaya;DEMONT & BREYER, LLC, 100 COMMONS WAY, STE 250, HOLMDEL, NJ, 07733, US

(73) Assignee: Avaya Inc., Basking Ridge, NJ (US)

(21) Appl. No.: 12/241,988

(22) Filed: Sep. 30, 2008

(51) Int. Cl. H04M 3/00

(52) U.S. Cl. 379/265.14

(57) ABSTRACT

A call center is described in which a caller to a call center is given a choice of which specific call-center agent the caller prefers to speak with. To assist the caller in making an informed decision, the call center provides the caller with: an indicium of two or more call-center agents, an indicium of an estimate of the amount of time before the caller can communicate with each of the call-center agents, an indicium of a satisfaction rating of each call-center agent, and other factors. The caller can then convey his or her preference to the call center, which will attempt to honor the preference by connecting the caller with the preferred call-center agent. This increases the likelihood that the caller will be connected with a call-center agent who is well-suited to dealing with the caller, which is beneficial to both the caller and the call center.

### FIELD OF THE INVENTION

The present invention relates to telecommunications in general, and, more particularly, to telecommunications call centers.

### BACKGROUND OF THE INVENTION

When a person has an issue with a product, the person often calls a call center that is associated with the enterprise that sold the product. These call centers are often reached by dialing toll-free “1-800” numbers.

When the call center answers the call, the caller is usually presented with a menu of choices such as “Press 1 for English or press 2 for Spanish.” After the caller makes his or her choice, the caller is, after some wait, connected to a call-center agent. All too often the call-center agent is ill-suited to dealing with the caller, which causes an unsatisfactory situation for both the caller and the call center. Therefore, the need exists for a more accommodating telecommunications call center.

### SUMMARY OF THE INVENTION

The present invention provides a call center that avoids some of the costs and disadvantages associated with call centers in the prior art. In accordance with the illustrative embodiment, a caller to a call center is given a choice of which specific call-center agent the caller prefers to speak with. To assist the caller in making an informed decision, the call center provides the caller with:
i. an indicium of two or more call-center agents,
ii. an indicium of an estimate of the amount of time before the caller can communicate with each of the call-center agents,
iii. an indicium of a satisfaction rating of each call-center agent,
iv. an indicium of one or more areas of expertise of each call-center agent,
v. an indicium of the first language spoken by each call-center agent,
vi. an indicium of the location of each call-center agent,
vii. an indicium of the age of each call-center agent, and
viii. an indicium of the gender of each call-center agent.
   The caller can then convey his or her preference to the call center, which attempts to honor the preference by connecting the caller with the preferred call-center agent. This increases the likelihood that the caller will be connected with a call-center agent who is well-suited to dealing with the caller, which is beneficial to both the caller and the call center.

The illustrative embodiment of the present invention comprises: (1) transmitting to a caller: (i) an indicium of a first call-center agent, (ii) an indicium of an estimated-wait time to communicate with the first call-center agent, (iii) an indicium of a second call-center agent, and (iv) an indicium of an estimated-wait time to communicate with the second call-center agent; and (2) receiving an indication from the caller of a preference to communicate with the first call-center agent or the second call-center agent.

### BRIEF DESCRIPTION OF THE DRAWINGS

FIG. 1 depicts a schematic diagram of the salient components of telecommunications system 100 in accordance with the illustrative embodiment of the present invention.

FIG. 2 depicts a flowchart of the salient tasks associated with the operation of the illustrative embodiment of the present invention.

### DETAILED DESCRIPTION

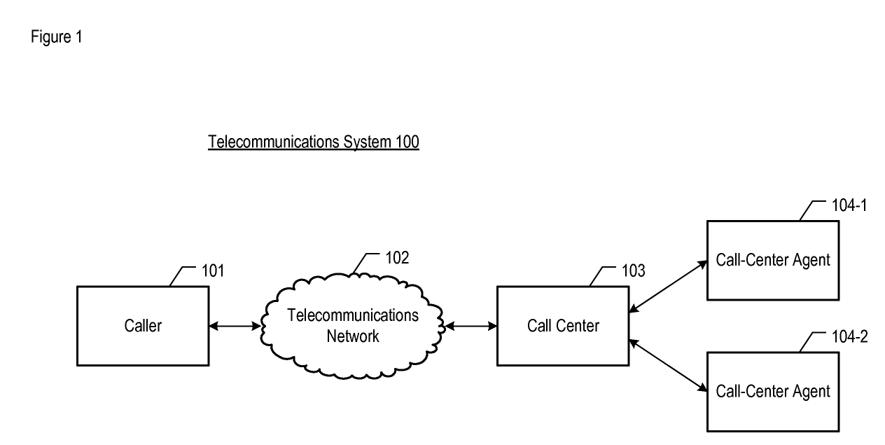

FIG. 1 depicts a schematic diagram of the salient components of telecommunications system 100 in accordance with the illustrative embodiment of the present invention. Telecommunications system 100 comprises: caller 100, telecommunications network 102, call center 103, call-center agent 104-1 and call-center agent 104-2. Although the illustrative embodiment comprises one caller, it will be clear to those skilled in the art, after reading this disclosure, how to make and use alternative embodiments of the present invention that comprise any number of callers. Although the illustrative embodiment comprises two call-center agents, it will be clear to those skilled in the art, after reading this disclosure, how to make and use alternative embodiments that comprise any number of call-center agents. Although the illustrative embodiment depicts call-center agents 104-1 and 104-2 co-located with call center 103, it will be clear to those skilled in the art, after reading this disclosure, how to make and use alternative embodiments of the present invention in one or more call-center agents are remotely connected to call center 103 through telecommunications network 102.

Caller 101 is a person who is desires to contact an enterprise for information regarding a product. In accordance with the illustrative embodiment, caller 101 contacts the enterprise via the telephone by dialing a number for call center 103, but it will be clear to those skilled in the art, after reading this disclosure, how to make and use alternative embodiments of the present invention in which the caller contacts the enterprise via another modality, such as, for example, and without limitation, instant messaging, short-message service, etc.

Telecommunications network 102 is the Public Switched Telephone Network, but it will be clear to those skilled in the art, after reading this disclosure, how to make and use alternative embodiments of the present invention in which telecommunication network 102 is another network, for example and without limitation, the Internet, a private data network, a satellite network, etc.

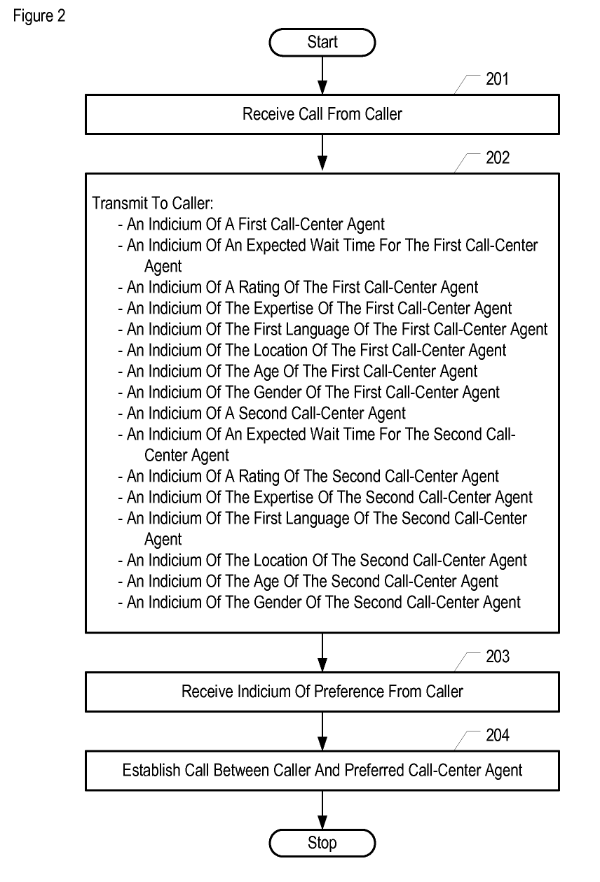

Call center 103 is hardware and software for receiving a call from caller 101, for communicating with caller 101, and for coordinating communication with caller 101 and call-center agents 104-1 and 104-2. In particular, call center 103 is capable of performing the functionality described below and with respect to FIG. 2.

Call-center agent 104-1 and call-center agent 104-2 are people who can assist caller 101 with regard to the product of interest. Each call-center agent has one or more areas of expertise, a satisfaction rating, a first language, a gender, an age, and is at a specific location. Furthermore, each call-center agent has a different queue of callers to be processed, and, therefore, has an estimated amount of time before they could talk with caller 101. Although the call-center agents are called agents, it does not imply the existence or absence of a principal-agent relationship between the call-center agent and call center 103 or the enterprise selling the product.

FIG. 2 depicts a flowchart of the salient tasks associated with the operation of the illustrative embodiment of the present invention.

At task 201, call center 103 receives a call from caller 101, in well-known fashion.

At task 202, call center 103 transmits to caller 101:
i. an indicium of call-center agent 104-1, and
ii. an indicium of the amount of time before caller 101 can communicate with call-center agent 104-1, and
iii. an indicium of a satisfaction rating of call-center agent 104-1, and
iv. an indicium of one or more areas of expertise of call-center agent 104-1, and
v. an indicium of the first language spoken by call-center agent 104-1, and
vi. an indicium of the location of call-center agent 104-1, and
vii. an indicium of the age of call-center agent 104-1, and
viii. an indicium of the gender of call-center agent 104-1, and
ix. an indicium of call-center agent 104-2, and
x. an indicium of the amount of time before caller 101 can communicate with call-center agent 104-2, and
xi. an indicium of a satisfaction rating of call-center agent 104-2, and
xii. an indicium of one or more areas of expertise of call-center agent 104-2, and
xiii. an indicium of the first language spoken by call-center agent 104-2, and
xiv. an indicium of the location of call-center agent 104-2, and
xv. an indicium of the age of call-center agent 104-2, and
xvi. an indicium of the gender of call-center agent 104-2.
   It will be clear to those skilled in the art, after reading this disclosure, how to make and use alternative embodiments of the present invention in which fewer than all of these indicia are transmitted to caller 101. Based on these indicia, caller 101 chooses which call-center agent he or she desires to speak with and communicates this preference to call center 103.

At task 203, call center 103 receives the preference from caller 101 of which call-center agent he or she would prefer to speak with.

At task 204, call center 103 honors the preference by establishing a call between caller 101 and the preferred call-center agent, when that agent is available.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
(1) transmitting to a caller:
(i) an indicium of a first call-center agent,
(ii) an indicium of an estimated-wait time to communicate with the first call-center agent,
(iii) an indicium of a second call-center agent, and
(iv) an indicium of an estimated-wait time to communicate with the second call-center agent; and
(2) receiving an indication from the caller of a preference to communicate with the first call-center agent or the second call-center agent.

2. The method of claim 1 further comprising transmitting to the caller:
(v) an indicium of a rating of the first call-center agent, and
(vi) an indicium of a rating of the second call-center agent.

3. The method of claim 1 further comprising transmitting to the caller:
(v) an indicium of the first language of the first call-center agent, and
(vi) an indicium of the first language of the second call-center agent.

4. The method of claim 1 further comprising transmitting to the caller:
(v) an indicium of the location of the first call-center agent, and
(vi) an indicium of the location of the second call-center agent.

5. The method of claim 1 further comprising transmitting to the caller:
(v) an indicium of the age of the first call-center agent, and
(vi) an indicium of the age of the second call-center agent.

6. The method of claim 1 further comprising transmitting to the caller:
(v) an indicium of the gender of the first call-center agent, and
(vi) an indicium of the gender of the second call-center agent.

7. A method comprising:
(1) transmitting to a caller:
(i) an indicium of a first call-center agent,
(ii) an indicium of a rating of the first call-center agent,
(iii) an indicium of a second call-center agent, and
(iv) an indicium of a rating of the second call-center agent; and
(2) receiving an indication from the caller of a preference to communicate with the first call-center agent or the second call-center agent.

8. The method of claim 7 further comprising transmitting to the caller:
(v) an indicium of the first language of the first call-center agent, and
(vi) an indicium of the first language of the second call-center agent.

9. The method of claim 7 further comprising transmitting to the caller:
(v) an indicium of the location of the first call-center agent, and
(vi) an indicium of the location of the second call-center agent.

10. The method of claim 7 further comprising transmitting to the caller:
(v) an indicium of the age of the first call-center agent, and
(vi) an indicium of the age of the second call-center agent.

11. The method of claim 7 further comprising transmitting to the caller:
(v) an indicium of the gender of the first call-center agent, and
(vi) an indicium of the gender of the second call-center agent.

12. A method comprising:
(1) transmitting to a caller:
(i) an indicium of a first call-center agent,
(ii) an indicium of an expertise of the first call-center agent,
(iii) an indicium of a second call-center agent, and
(iv) an indicium of an expertise of the second call-center agent; and
(2) receiving an indication from the caller of a preference to communicate with the first call-center agent or the second call-center agent.

13. The method of claim 12 further comprising transmitting to the caller:
(v) an indicium of a rating of the first call-center agent, and
(vi) an indicium of a rating of the second call-center agent.

14. The method of claim 12 further comprising transmitting to the caller:
(v) an indicium of an estimated-wait time to communicate with the first call-center agent, and
(vi) an indicium of an estimated-wait time to communicate with the second call-center agent.

15. The method of claim 12 further comprising transmitting to the caller:
(v) an indicium of the first language of the first call-center agent, and
(vi) an indicium of the first language of the second call-center agent.

16. The method of claim 12 further comprising transmitting to the caller:
(v) an indicium of the location of the first call-center agent, and
(vi) an indicium of the location of the second call-center agent.

17. The method of claim 12 further comprising transmitting to the caller:
(v) an indicium of the age of the first call-center agent, and
(vi) an indicium of the age of the second call-center agent.

18. The method of claim 12 further comprising transmitting to the caller:
(v) an indicium of the gender of the first call-center agent, and
(vi) an indicium of the gender of the second call-center agent.
